(19) United States
(12) Patent Application Publication
(10) Pub. No.: US 2019/0135276 A1
(43) Pub. Date: May 9, 2019

(54) VEHICLE CONTROL SYSTEM AND METHOD

(71) Applicant: MANDO CORPORATION, Pyeongtaek-si (KR)

(72) Inventor: Sang Yeob LEE, Seongnam-si (KR)

(21) Appl. No.: 16/180,544

(22) Filed: Nov. 5, 2018

(30) Foreign Application Priority Data
Nov. 3, 2017 (KR) 10-2017-0146233
Feb. 27, 2018 (KR) 10-2018-0023800

(51) Int. Cl. B60W 30/09; B60W 10/20; B60W 10/18; B60W 30/095; B60W 30/14; B60W 30/12

(52) U.S. Cl. CPC B60W 30/09; B60W 10/20; B60W 10/18; B60W 30/0956; B60W 30/143; B60W 2710/20; B60W 2550/302; B60W 2550/308; B60W 2550/141; B60W 2710/18; B60W 30/12

(57) ABSTRACT

A vehicle control system and method through peripheral collision situation prediction are disclosed. The vehicle control system includes omnidirectional sensors configured to sense distances and relative speeds between a host vehicle and peripheral objects and to transmit the distances and the relative speeds to an electronic control unit, vehicle dynamics sensors configured to sense a driving speed of the host vehicle and to transmit the driving speed to the electronic control unit, and the electronic control unit configured to receive sensing signals from the omnidirectional sensors and the vehicle dynamics sensors, to predict collision risk between a plurality of the peripheral objects and to execute control so as to perform braking avoidance and steering avoidance of the peripheral objects, thus being capable of preventing a secondary accident or a pile-up.

### CROSS-REFERENCE TO RELATED APPLICATION

This application is based on and claims priority under 35 U.S.C. § 119 to Korean Patent Application Nos. 10-2017-0146233, filed on Nov. 3, 2017, and 10-2018-0023800, filed on Feb. 27, 2018 in the Korean Intellectual Property Office, the disclosure of which is incorporated by reference in its entirety.

### BACKGROUND

### 1. Field

Embodiments of the present disclosure relate to a vehicle control system and method through peripheral collision situation prediction, and more particularly to a vehicle control system and method through peripheral collision situation prediction which may prevent secondary accidents by predicting collision situations around the vehicle.

Further, embodiments of the present disclosure relate to an autonomous emergency braking system and method interworking with a highway driving assist (HDA) system, and more particularly to an autonomous emergency braking system and method interworking with a highway driving assistant system, which may support safety-preferred driving of a vehicle by increasing warning and braking distances of the autonomous emergency braking (AEB) system if a lane keeping assist (LKA) function and a smart cruise control (SCC) function are activated during driving on a highway.

### 2. Description of the Related Art

In general, a forward collision warning and mitigation system of a vehicle is a system which warns a driver about collision risk according to a degree of collision risk with a preceding vehicle or performs autonomous braking, as needed and thus minimizes a collision speed, when a dangerous obstacle in front of the vehicle, such as the preceding vehicle, is sensed during driving of the vehicle.

However, the conventional forward collision warning and mitigation system performs vehicle control by calculating only a degree of collision risk between the host vehicle and the preceding vehicle and thus has a difficulty in preventing a secondary accident or a pile-up by coping with a dangerous situation, in which movement of peripheral vehicles is not predicted, such as collision between peripheral vehicles, in advance.

A highway is a road prepared so that vehicles drive thereon at a high speed and, in case of an accident on the highway, a major accident may be caused.

A highway driving assist (HDA) system applicable to driving of a vehicle on such a highway allows the vehicle to autonomously keep a lane and to maintain a distance with a preceding vehicle on the highway and thus facilitates partial autonomous driving of the vehicle by integrating lane keeping assist (LKA), smart cruise control (SCC) and navigation information (map data, GPS data, etc.), and an autonomous emergency braking (AEB) system of a vehicle warns a driver about collision risk according to a degree of collision risk with a preceding vehicle or performs autonomous braking as needed, when a dangerous obstacle, such as the preceding vehicle, is sensed during driving of the vehicle, and thus prevents a collision accident.

Accordingly, since a vehicle, when the vehicle drives on a highway, mainly drives straight and particularly, when the vehicle drives while operating the HDA system, drives along the center of a road without lane change, the vehicle mainly performs braking control so as to avoid risk, in case of occurrence of a dangerous situation. However, in order not to provide inconvenience to a driver by reducing a braking amount in a wrong vehicle sensing situation or a proximate overtaking situation, the conventional AEB system performs stepwise braking control in which designated warning and braking distances are generally given regardless of attributes of a road on which the vehicle drives and full braking of 1.0 g is carried out after pre-braking of 0.2 g, as exemplarily shown in FIGS. 3A and 3B, thus being limited in terms of avoidance of a dangerous situation when the vehicle drives on a highway other than a general road.

Accordingly, the present disclosure proposes technology which supports safety-preferred driving by increasing warning and braking distances of an autonomous emergency braking (AEB) system if a lane keeping assist (LKA) function and a smart cruise control (SCC) function are activated during driving on a highway, and supports sensitive operation prevention-preferred driving by restoring the warning and braking distances in other situations.

### SUMMARY

Therefore, it is an aspect of the present disclosure to provide a vehicle control system and method through peripheral collision situation prediction, which may prevent a secondary accident in consideration of collisions between peripheral vehicles by predicting not only a degree of collision risk with a preceding vehicle but also a degree of collision risk between a plurality of vehicles around a host vehicle.

It is another aspect of the present disclosure to provide an autonomous emergency braking (AEB) system and method interworking with a highway driving assist (HDA) system, which may support safety-preferred driving of a vehicle by increasing warning and braking distances of the autonomous emergency braking (AEB) system if a lane keeping assist (LKA) function and a smart cruise control (SCC) function are activated during driving on a highway, and support sensitive operation prevention-preferred driving by restoring the warning and braking distances in other situations.

Additional aspects of the disclosure will be set forth in part in the description which follows and, in part, will be obvious from the description, or may be learned by practice of the disclosure.

In accordance with an aspect of the present disclosure, a vehicle control system includes omnidirectional sensors configured to sense distances and relative speeds between a host vehicle and peripheral objects and to transmit the distances and the relative speeds to an electronic control unit, vehicle dynamics sensors configured to sense a driving speed of the host vehicle and to transmit the driving speed to the electronic control unit, and the electronic control unit configured to receive sensing signals from the omnidirectional sensors and the vehicle dynamics sensors, to predict collision risk between a plurality of the peripheral objects and to execute control so as to perform braking avoidance and steering avoidance of the peripheral objects.

The electronic control unit may calculate degrees of collision risk between the peripheral objects, calculate degrees of collision risk between colliding objects and the host vehicle if a collision situation between the peripheral objects is determined according to the calculated degrees of collision risk, and perform braking avoidance or steering avoidance.

The degree of collision risk may be a collision required time taken to reach collision between two objects.

The electronic control unit may determine that collision between the two objects occurs, if the collision required time between the two objects is shorter than a reference time to determine collision between the two objects.

When a collision situation between the peripheral objects is determined, the electronic control unit may perform braking avoidance or steering avoidance if collision required times between colliding objects and the host vehicle are shorter than a time to determine whether or not control entry of the host vehicle is necessary.

If control entry of the host vehicle is necessary, the electronic control unit may perform braking avoidance control if distances between the host vehicle and the colliding objects are shorter than a braking avoidance distance, when relative speeds between the host vehicle and the colliding objects are lower than a reference relative speed, and perform steering avoidance control if the distances between the host vehicle and the colliding objects are shorter than a steering avoidance distance, when the relative speeds between the host vehicle and the colliding objects are higher than the reference relative speed.

In accordance with another aspect of the present disclosure, an autonomous emergency braking system includes vehicle dynamics sensors configured to sense a driving speed of a host vehicle and to transmit the driving speed to an electronic control unit, driver assistance system (DAS) sensors configured to sense distances and relative speeds between the host vehicle and peripheral objects or to transmit an image around the host vehicle to the electronic control unit, and the electronic control unit configured to receive sensing signals from the vehicle dynamics sensors and the DAS sensors and to activate a safety-preferred control mode during autonomous emergency braking (AEB), in a situation in which the host vehicle drives on a highway and lane keeping assist (LKA) and smart cruise control (SCC) are executed.

The safety-preferred control mode may be a mode configured to execute parabolic braking control by advancing warning and braking operation times by increasing warning and braking distances, as compared to driving on a general road, and calculating a required deceleration amount.

The electronic control unit may execute stepwise braking control in which full braking is carried out after pre-braking by maintaining the same warning and braking distances as those in driving on the general road and calculating a required deceleration amount, in a situation in which the host vehicle does not drive on the highway, or the host vehicle drives on the highway but the lane keeping assist (LKA) and the smart cruise control (SCC) are not executed.

The electronic control unit may execute stepwise braking control in which full braking is carried out after pre-braking by maintaining the same warning and braking distances as those in driving on the general road and calculating a required deceleration amount, if a driver's vehicle operating intention is sensed.

The required deceleration amount may be is calculated as

$${A}_{req} = \frac{{V}_{rel}^{2}}{2 \times {D}_{rel}} ,$$

A_{req} may be the required deceleration amount, Vᵣₑₗ may be a relative speed between the host vehicle and a preceding vehicle, and Dᵣₑₗ may be a relative distance between the host vehicle and the preceding vehicle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram schematically illustrating an overall configuration of a vehicle control system in accordance with one embodiment of the present disclosure;

FIG. 2 is a flowchart schematically illustrating an overall process of a vehicle control method in accordance with one embodiment of the present disclosure;

FIGS. 3A to 3C are views illustrating a vehicle control process in accordance with one embodiment of the present disclosure;

FIG. 4 is a view illustrating distances and relative speeds between a host vehicle and vehicles located around the host vehicle;

FIG. 5 is a graph illustrating relations among a braking avoidance distance and a steering avoidance distance and a relative speed between a host vehicle and a peripheral object;

FIG. 6 is a flowchart schematically illustrating an overall process of an autonomous emergency braking method in accordance with one embodiment of the present disclosure;

FIG. 7A is a view illustrating warning and braking distances when a vehicle drives on a general road;

FIG. 7B is a view illustrating warning and braking distances when the vehicle drives on a highway;

FIG. 8A is a view illustrating a deceleration pattern when the vehicle drives on the general road; and

FIG. 8B is a view illustrating a deceleration pattern when the vehicle drives on the highway.

### DETAILED DESCRIPTION

Advantages and features of the present disclosure and a method of achieving the advantages and features of the present disclosure will be clearly understood from embodiments described hereinafter in conjunction with the accompanying drawings. However, the present disclosure is not limited to the following embodiments and may be realized in various different forms. These embodiments are provided only to completely disclose the present disclosure and for a person having ordinary skill in the art to which the present disclosure pertains to completely understand the category of the disclosure. That is, the present disclosure is defined only by the claims. The same reference numbers will be used throughout this specification to refer to the same parts.

Hereinafter, a vehicle control system and method in accordance with the present disclosure will be described in detail with reference to the accompanying drawings.

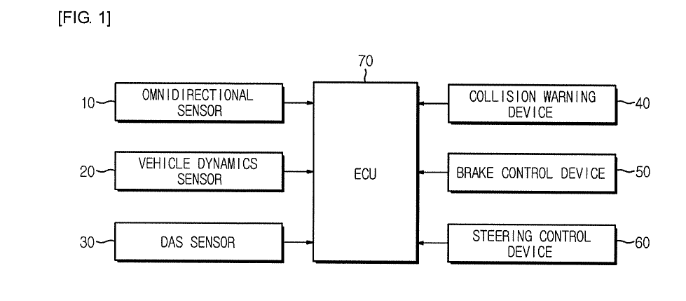

FIG. 1 is a block diagram schematically illustrating an overall configuration of a vehicle control system in accordance with one embodiment of the present disclosure.

As exemplarily shown in FIG. 1, the vehicle control system applied to the present disclosure includes omnidirectional sensors 10, vehicle dynamics sensors 20, driver assistance system (DAS) sensors 30, an electronic control unit (ECU) 70, a collision warning device 40, a brake control device 50 and a steering control device 60.

The omnidirectional sensor 10 may be one of various well-known sensors, such as a radar sensor, etc., and is provided at the center and a corner of a front surface of a vehicle, emits beams within the range of a designated angle with respect to a forward region of the omnidirectional sensor 10 and then receives waves reflected by objects located around a host vehicle, thus sensing angles, distances, relative speeds, relative accelerations, etc. between the host vehicle and the objects and transmitting the same to the ECU 70.

The vehicle dynamics sensor 20 may be one of various well-known sensors, such as a wheel sensor, etc., and may be provided at front, rear, left and right wheels of the vehicle, senses a driving speed, an acceleration, etc. of the host vehicle and transmits the same to the ECU 70. Further, the vehicle dynamics sensor 20 may be one of various well-known sensors, such as a wheel speed sensor, an acceleration sensor, a yaw rate sensor, a steering angle sensor, etc., and may be disposed at proper positions, such as a wheel, a steering wheel, etc. of the vehicle, sense driving a driving speed, an acceleration, a yaw angular speed, a steering angle, etc., of the host vehicle and transmit the same to the ECU 70.

The DAS sensor 30 may be one of various well-known sensors, such as a radar sensor, etc., and may be provided at the center and a corner of the front surface of the vehicle, emit electromagnetic waves within the range of a designated angle with respect to a forward region of the DAS sensor 30 and then receive electromagnetic waves reflected by objects located around the vehicle, thus sensing angles, distances, relative speeds, relative accelerations, etc. between the host vehicle and the objects and transmitting the same to the ECU 70. Further/otherwise, the DAS sensor 30 may be one of various well-known image sensors, such as a FIR camera, a CMOS camera (or a CCD camera), etc., and may be provided at a front end of a front window of the vehicle, sense and emit light of various bands, such as an infrared wavelength region, a visible wavelength region, etc., within the range of a designated angle and a designated distance with respect to a forward region of the camera, and thus acquire an external object image and transmit the acquired image to the ECU 70.

The collision warning device 40 serves to a control signal from the ECU 70 and to warn the driver about collision risk with a front obstacle, and the brake control device 50 serves to receive a control signal from the ECU 70 and to generate brake pressure of the vehicle, and the steering control device 60 serves to receive a control signal from the ECU 70 and to generate a steering angle of the steering wheel.

Further, the collision warning device 40 serves to receive a control signal from the ECU 70 and to warn the driver about collision risk with a front obstacle, and the brake control device 50 serves to receive a control signal from the ECU 70 and to generate brake pressure of the vehicle.

The ECU 70 receives sensing signals from the omnidirectional sensors 10 and the vehicle dynamics sensors 20, calculates degrees of collision risk between a plurality of objects located around the host vehicle, calculates a degree of collision risk between colliding objects and the host vehicle if a collision situation between the objects around the host vehicle is determined according to the calculated degrees of collision risk between the objects, and generates collision warning or performs braking avoidance or steering avoidance.

The ECU 70 receives sensing signals from the vehicle dynamics sensors 20 and the DAS sensors 30, increases warning and braking distances and thus advances warning and braking operation times, as compared to driving on a general road, by activating a safety-preferred control mode in a situation in which the vehicle drives on a highway and lane keeping assist (LKA) serving as transverse steering control and smart cruise control (SCC) serving as longitudinal speed control are executed, calculates a necessary deceleration amount and thus gradually decelerates the vehicle. In other situations, the ECU 70 restores the warning and braking distances and thus performs conventional AEB control.

The present disclosure proposes a method for calculating a degree of collision risk between a plurality of objects located around a host vehicle, calculating degrees of collision risk between colliding objects and the host vehicle if a collision situation between the objects around the host vehicle is determined according to the calculated degree of collision risk between the objects, and then generating collision warning or performing braking avoidance or steering avoidance.

Further, the present disclosure proposes a method of increasing warning and braking distances by activating the safety-preferred control mode in a situation in which the vehicle drives on a highway and lane keeping assist (AKA) serving as transverse steering control and smart cruise control (SCC) serving as longitudinal speed control are executed.

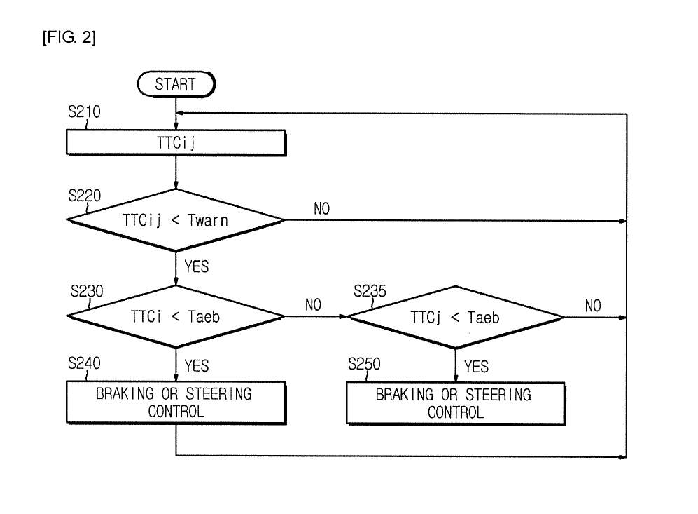

Hereinafter, a vehicle control method through peripheral collision situation prediction using the above-configured system in accordance with the present disclosure will be described with reference to FIGS. 2 to 4.

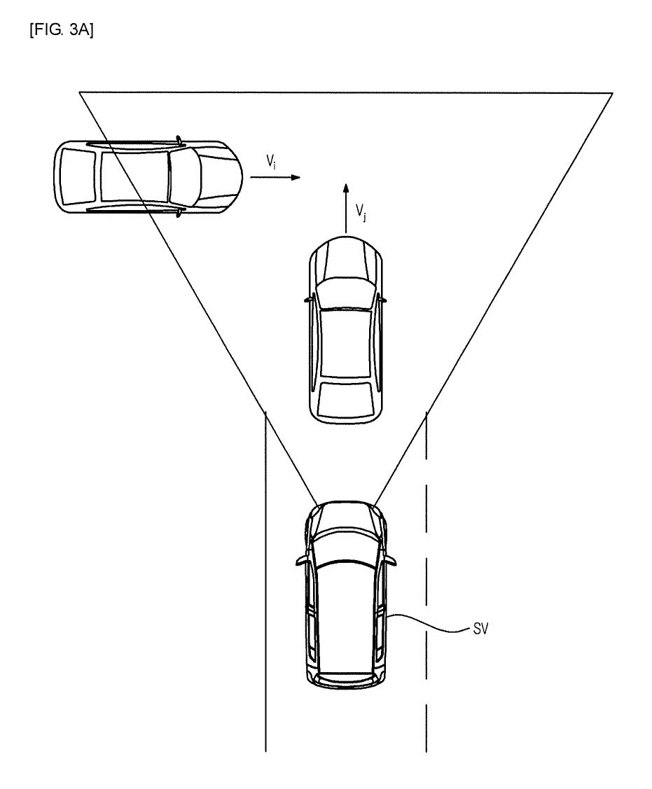

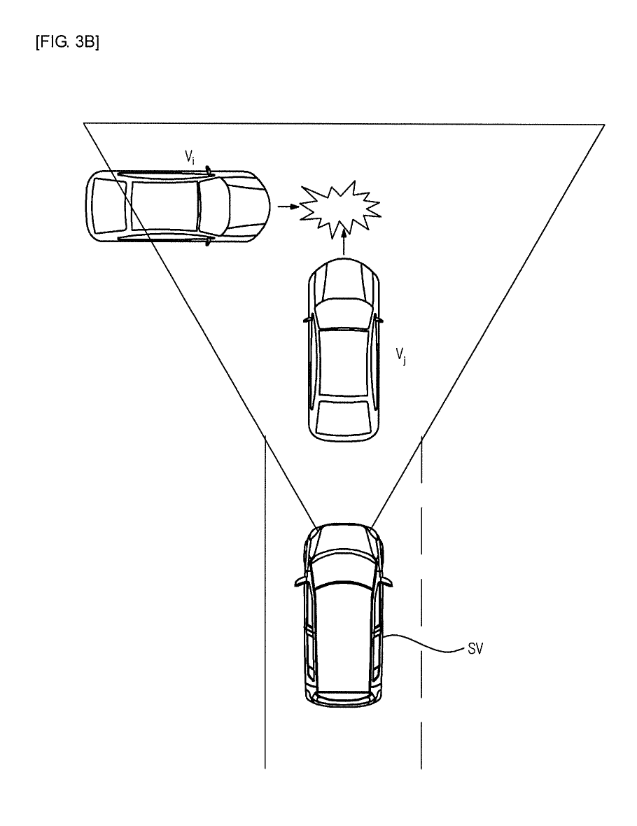

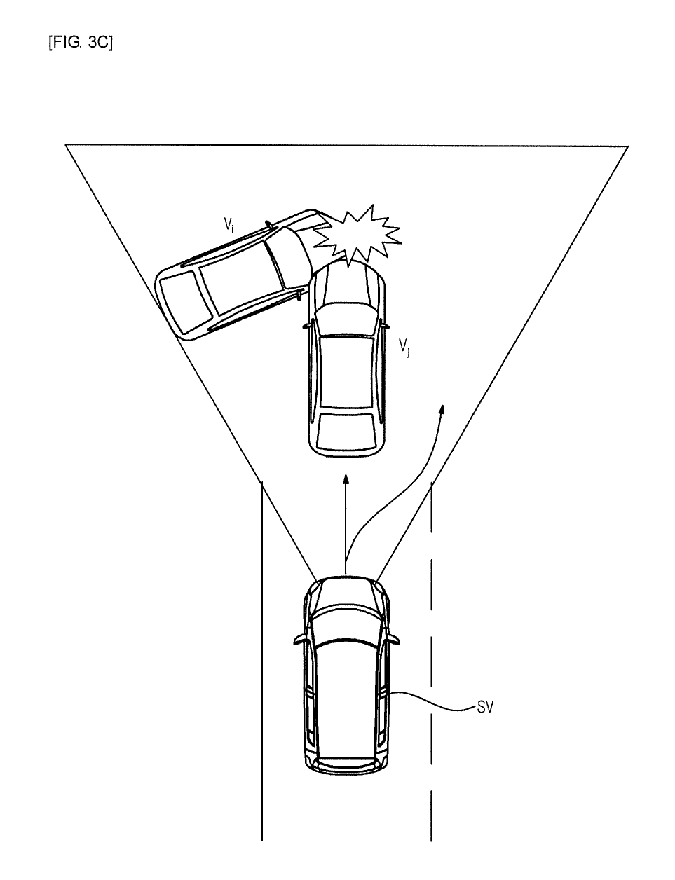

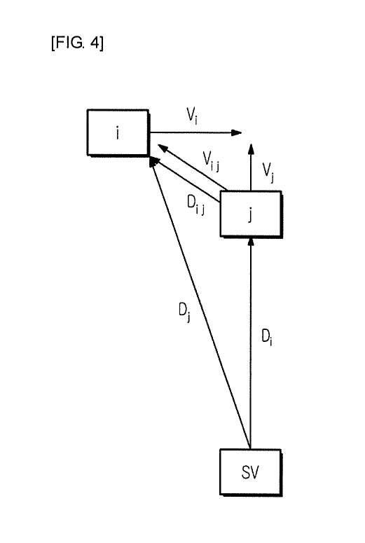

As exemplarily shown in FIGS. 2 to 5, the ECU 70 receives sensing signals from the omnidirectional sensors 10 and the vehicle dynamics sensors 20 and respectively calculates degrees of collision risk between a plurality of objects around the vehicle, as exemplarily shown in FIG. 3A (Operation S210). That is, referring to FIG. 4, as a degree of collision risk between a first vehicle i and a second vehicle j located around the host vehicle, a collision required time TTCᵢⱼ taken to reach collision between the two objects is calculated. Here, the collision required time TTCᵢⱼ is calculated by dividing a distance between the first vehicle i and the second vehicle j by a relative speed, as stated in Equation 1 below.

$${TTC}_{ij} = \frac{{D}_{ij}}{{V}_{ij}} = \frac{{D}_{j} - {D}_{i}}{{V}_{j} - {V}_{i}} \qquad [ Equation 1 ]$$

Thereafter, the ECU 70 determines a collision situation between the peripheral vehicles by comparing the above-calculated collision required time TTCᵢⱼ between the peripheral vehicles to a reference time TTCwarn (for example, 0.1 seconds) to determine collision between the peripheral vehicles (Operation S220). That is, the ECU 70 may determine that collision between the peripheral vehicles occurs and thus execute subsequent Operations S which will be described below so as to perform control through peripheral collision situation prediction, if the collision required time TTCᵢⱼ between the peripheral vehicles is shorter than the reference time TTC_{warn} to determine collision between the peripheral vehicles, and execute the conventional autonomous emergency braking (AEB) control instead of control through peripheral collision situation prediction, if the collision required time TTCᵢⱼ between the peripheral vehicles is not shorter than the reference time TTC_{warm} to determine collision between the peripheral vehicles.

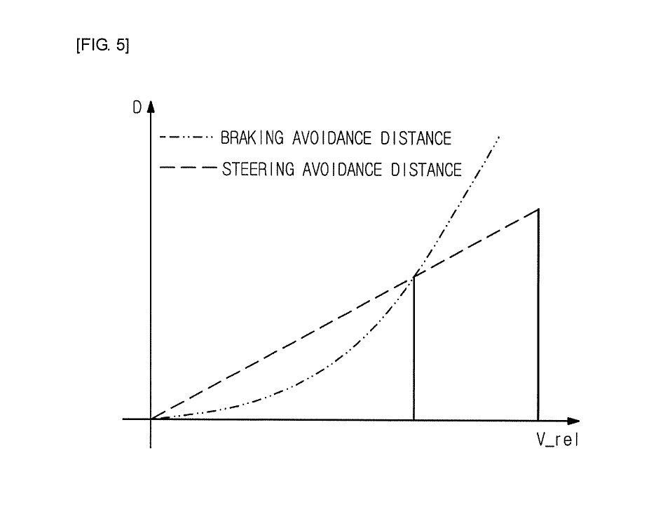

When the collision situation between the peripheral vehicles is determined in Operation S220, as exemplarily shown in FIG. 38, the ECU 20 in accordance with the present disclosure calculates degrees of collision risk between the colliding vehicles i and j and the host vehicle sv, respectively, and controls the vehicle so as to prevent a secondary accident by performing braking of the host vehicle sv if braking of the vehicle is possible or performing steering of the host vehicle sv if collision avoidance of the colliding vehicles i and j through steering is necessary, as exemplarily shown in FIG. 3C. That is, collision required times TTCᵢ and TTCⱼ i.e., values acquired by dividing distances between the colliding vehicles i and j and the host vehicle sv by relative speeds therebetween are respectively calculated as degrees of collision risk between the colliding vehicles i and j and the host vehicle sv, and then the calculated collision required times TTCᵢ and TTCⱼ, are compared to a time TTC_{aeb} to determine whether or not control entry of the vehicle is necessary (for example, 2 seconds) (Operations S230 and S235). That is, when the respective collision required times TTCᵢ and TTCⱼ of the colliding vehicles i and j are shorter than the time TTC_{aeb} to determine whether or not control entry of the vehicle is necessary, which regions of the graph of FIG. 5, illustrating relations among a distance to avoid collision through braking (hereinafter referred to as ‘a braking avoidance distance’) and a distance to avoid collision through steering (hereinafter referred to as ‘a steering avoidance distance’) and a relative speed between the host vehicle and a peripheral object, do the distances Dᵢ and Dⱼ and the relative speeds V_rel between the colliding vehicles i and j and the host vehicle sv belong to are determined and, accordingly, braking avoidance control or steering avoidance control of the host vehicle sv with respect to the colliding vehicles i and j is performed (Operations S240 and S250).

In more detail, if the relative speed V_rel between the host vehicle sv and each of the colliding vehicles i and j is lower than a reference relative speed at which the braking avoidance distance and the steering avoidance distance intersect, the ECU 70 uses the braking avoidance distance as a main factor, transmits a control signal to the brake control device 50 and thus performs braking avoidance control so that the brake control device 50 generates brake pressure of the vehicle, when each of the distances Dᵢ and Dⱼ is shorter than the braking avoidance distance and, if the relative speed V_rel between the host vehicle sv and each of the colliding vehicles i and j is higher than the reference relative speed, the ECU 70 uses the steering avoidance distance as a main factor, transmits a control signal to the steering control device 60 and thus performs steering avoidance control so that the steering control device 60 generates a steering angle of the steering wheel of the vehicle, when each of the distances Dᵢ and Dⱼ is shorter than the steering avoidance distance. Here, the braking avoidance distance may be calculated using a speed of the host vehicle, an acceleration of the host vehicle, a relative speed of the host vehicle with a target vehicle, a relative acceleration of the host vehicle with the target vehicle, a delay time and a target longitudinal acceleration value, and the steering avoidance distance may be calculated using the speed of the host vehicle, the relative speed of the host vehicle with a target vehicle, the delay time and a target lateral acceleration value. Further, a braking control amount may be calculated as

$$\frac{V\_rel * V\_rel}{2 \text{/} distance} ,$$

and steering control may be executed so that the vehicle follows a path determined as a free space using a camera provided at the vehicle.

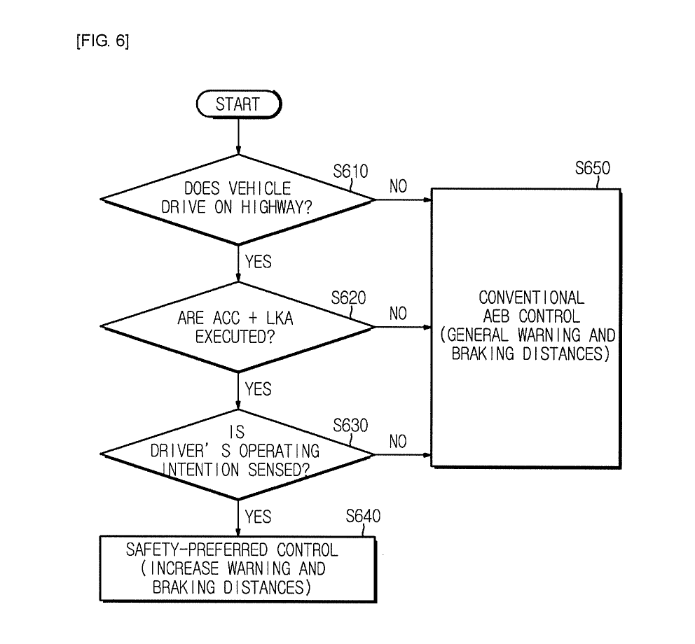

Hereinafter, a highway driving assist system-interworked autonomous emergency braking method in accordance with the present disclosure using the above-configured system will be described with reference to FIG. 6.

As exemplarily shown in FIG. 6, the ECU 70 determines whether or not the vehicle drives on a highway by receiving sensing signals from the vehicle dynamics sensors 20 and the DAS sensors 30 and grasping attributes of a road on which the vehicle drives (S610).

Thereafter, if it is determined that the vehicle drives on the highway (S610), the ECU 70 determines whether or not LKA and SCC are executed (S620).

Thereafter, if it is determined that LKA and SCC are executed (S620), the ECU 70 determines whether or not a driver's vehicle operating intention (for example, an act of manipulating a blinker, a steering wheel, an accelerator pedal, or a brake pedal) is sensed (S630).

Further, if the driver's vehicle operating intention is not sensed (S630), warning and braking distances of the autonomous emergency braking (AEB) system are increased, as compared to driving on a general road, and thus warning and braking operation times are advanced, and AEB control is executed through a parabolic braking control method in which a required deceleration amount is calculated and thus the vehicle is gradually decelerated, as exemplarily shown in

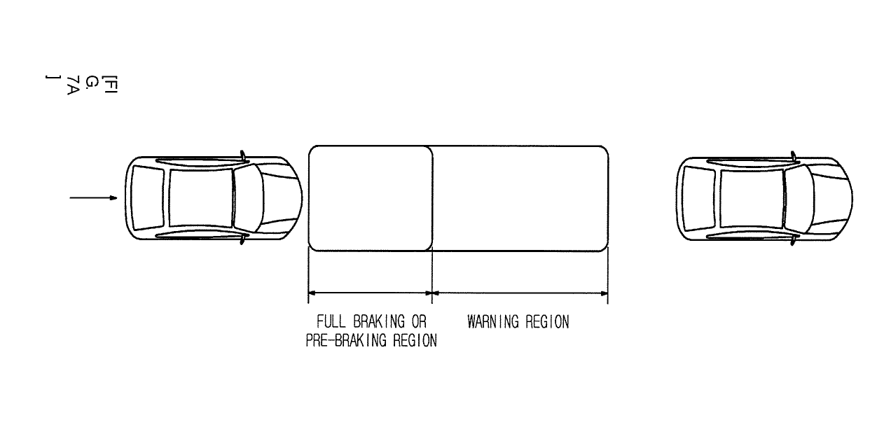

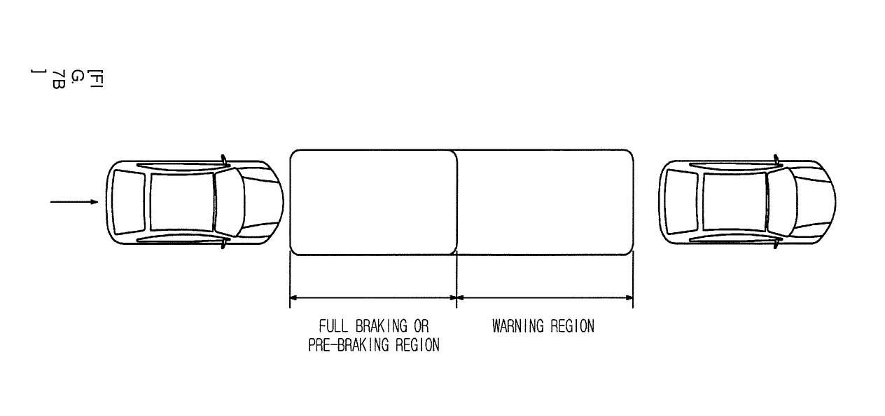

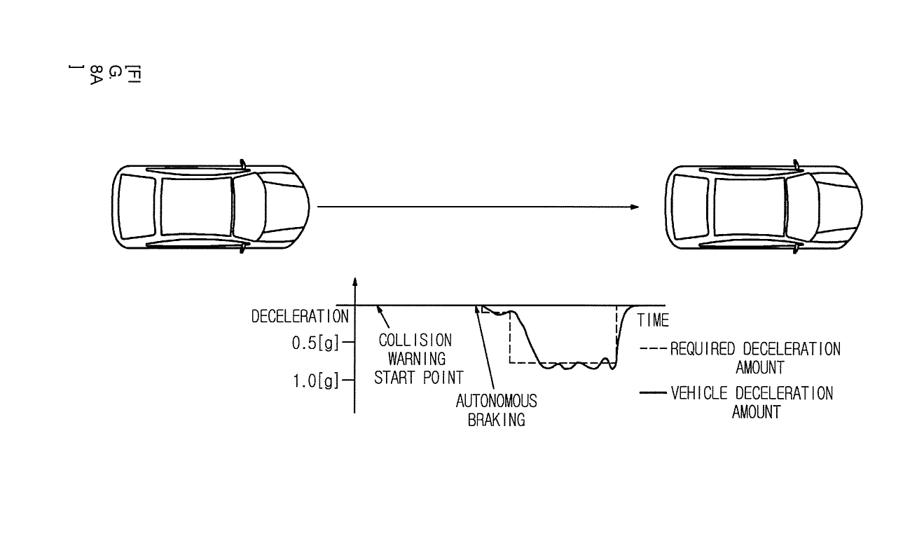

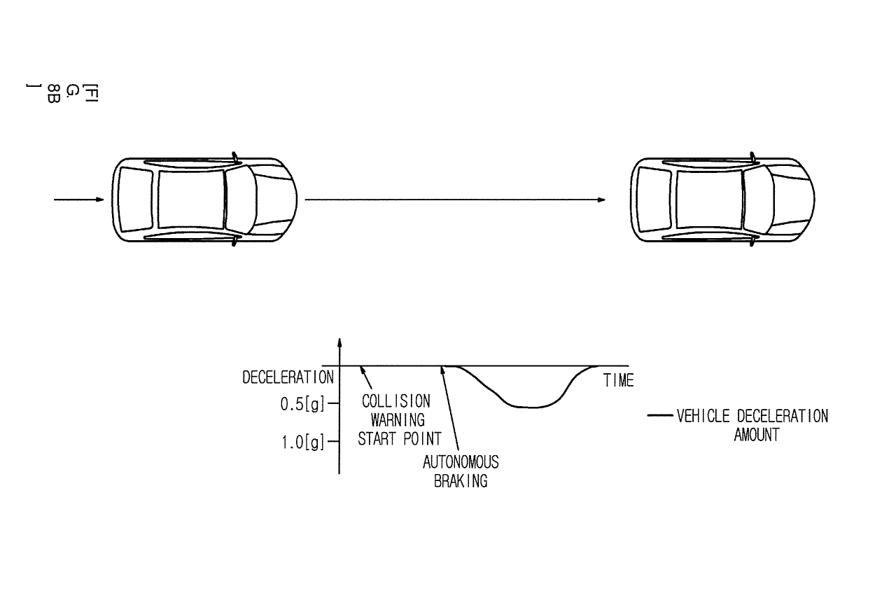

FIGS. 7B and 8B, thereby supporting safety-preferred driving (S640). Here, the required deceleration amount may be calculated by Equation 2 below.

$${A}_{req} = \frac{{V}_{rel}^{2}}{2 \times {D}_{rel}} \qquad [ Equation 2 ]$$

Here, A_{req} is the required deceleration amount, Vᵣₑₗ is a relative speed between the host vehicle and a preceding vehicle, and Dᵣₑₗ is a relative distance between the host vehicle and the preceding vehicle.

On the other hand, if it is determined that the vehicle does not drive on a highway, LKA and SCC are not executed, or the driver's vehicle operating intention is sensed (S610, S620 or S630), AEB control is executed through the conventional AEB control method (for example, the stepwise braking control method in which the warning and braking distances shown in FIGS. 7A and 8A are given and full braking of 1.0 g is carried out after pre-braking of 0.2 g), thereby supporting sensitive operation prevention-preferred driving (S650).

As is apparent from the above description, a vehicle control system and method through peripheral collision situation prediction in accordance with the present disclosure may calculate degrees of collision risk between a plurality of objects located around a host vehicle, calculate degrees of collision risk between colliding objects and the host vehicle if a collision situation between the objects around the host vehicle is determined according to the calculated degrees of collision risk between the objects, and generate collision warning or perform braking avoidance or steering avoidance, thus being capable of preventing a secondary accident or a pile-up.

Further, a highway driving assist system-interworked autonomous emergency braking system and method in accordance with the present disclosure may support safety-preferred driving of a vehicle by increasing warning and braking distances of an autonomous emergency braking (AEB) system if lane keeping assist (LKA) and smart cruise control (SCC) are activated during driving on a highway, and support sensitive operation prevention-preferred driving by restoring the warning and braking distances in other situations.

Although a few embodiments of the present disclosure have been shown and described, it would be appreciated by those skilled in the art that changes may be made in these embodiments without departing from the principles and spirit of the disclosure, the scope of which is defined in the claims and their equivalents.

1. A vehicle control system comprising:
omnidirectional sensors configured to sense distances and relative speeds between a host vehicle and peripheral objects and to transmit the distances and the relative speeds to an electronic control unit;
vehicle dynamics sensors configured to sense a driving speed of the host vehicle and to transmit the driving speed to the electronic control unit; and
the electronic control unit configured to receive sensing signals from the omnidirectional sensors and the vehicle dynamics sensors, to predict collision risk between a plurality of the peripheral objects and to execute control so as to perform braking avoidance and steering avoidance of the peripheral objects.

2. The vehicle control system according to claim 1, wherein the electronic control unit calculates degrees of collision risk between the peripheral objects, calculates degrees of collision risk between colliding objects and the host vehicle if a collision situation between the peripheral objects is determined according to the calculated degrees of collision risk, and performs braking avoidance or steering avoidance.

3. The vehicle control system according to claim 2, wherein the degree of collision risk is a collision required time taken to reach collision between two objects.

4. The vehicle control system according to claim 3, wherein the electronic control unit determines that collision between the two objects occurs, if the collision required time between the two objects is shorter than a reference time to determine collision between the two objects.

5. The vehicle control system according to claim 1, wherein, when a collision situation between the peripheral objects is determined, the electronic control unit performs braking avoidance or steering avoidance if collision required times between colliding objects and the host vehicle are shorter than a time to determine whether or not control entry of the host vehicle is necessary.

6. The vehicle control system according to claim 5, wherein, if control entry of the host vehicle is necessary, the electronic control unit:
performs braking avoidance control if distances between the host vehicle and the colliding objects are shorter than a braking avoidance distance, when relative speeds between the host vehicle and the colliding objects are lower than a reference relative speed; and
performs steering avoidance control if the distances between the host vehicle and the colliding objects are shorter than a steering avoidance distance, when the relative speeds between the host vehicle and the colliding objects are higher than the reference relative speed.

7. A vehicle control method comprising:
receiving distances and relative speeds between a host vehicle and peripheral objects and a driving speed of the host vehicle from sensors;
predicting a collision situation between a plurality of the peripheral objects; and
executing control so as to perform braking avoidance and steering avoidance of the peripheral objects.

8. The vehicle control method according to claim 7, wherein:
the predicting the collision situation between the peripheral objects comprises calculating degrees of collision risk between the peripheral objects; and
the executing the control comprises:
calculating degrees of collision risk between colliding objects and the host vehicle if a collision situation between the peripheral objects is determined according to the calculated degrees of collision risk; and
performing braking avoidance or steering avoidance according to the calculated degrees of collision risk between the colliding objects and the host vehicle.

9. The vehicle control method according to claim 8, wherein the degree of collision risk is a collision required time taken to reach collision between two objects.

10. The vehicle control method according to claim 9, wherein the executing the control further comprises determining that collision between the two objects occurs, if the collision required time between the two objects is shorter than a reference time to determine collision between the two objects.

11. The vehicle control method according to claim 7, wherein the executing the control comprises, when a collision situation between the peripheral objects is determined, performing braking avoidance or steering avoidance if collision required times between colliding objects and the host vehicle are shorter than a time to determine whether or not control entry of the host vehicle is necessary.

12. The vehicle control method according to claim 11, wherein the executing the control further comprises, if control entry of the host vehicle is necessary:
performing braking avoidance control if distances between the host vehicle and the colliding objects are shorter than a braking avoidance distance, when relative speeds between the host vehicle and the colliding objects are lower than a reference relative speed; and
performing steering avoidance control if the distances between the host vehicle and the colliding objects are shorter than a steering avoidance distance, when the relative speeds between the host vehicle and the colliding objects are higher than the reference relative speed.

13. An autonomous emergency braking system comprising:
vehicle dynamics sensors configured to sense a driving speed of a host vehicle and to transmit the driving speed to an electronic control unit;
driver assistance system (DAS) sensors configured to sense distances and relative speeds between the host vehicle and peripheral objects or to transmit an image around the host vehicle to the electronic control unit; and
the electronic control unit configured to receive sensing signals from the vehicle dynamics sensors and the DAS sensors and to activate a safety-preferred control mode during autonomous emergency braking (AEB), in a situation in which the host vehicle drives on a highway and lane keeping assist (LKA) and smart cruise control (SCC) are executed.

14. The autonomous emergency braking system according to claim 13, wherein the safety-preferred control mode is a mode configured to execute parabolic braking control by advancing warning and braking operation times by increasing warning and braking distances, as compared to driving on a general road, and calculating a required deceleration amount.

15. The autonomous emergency braking system according to claim 14, wherein the electronic control unit executes stepwise braking control in which full braking is carried out after pre-braking by maintaining the same warning and braking distances as those in driving on the general road and calculating a required deceleration amount, in a situation in which the host vehicle does not drive on the highway, or the host vehicle drives on the highway but the lane keeping assist (LKA) and the smart cruise control (SCC) are not executed.

16. The autonomous emergency braking system according to claim 14, wherein the electronic control unit executes stepwise braking control in which full braking is carried out after pre-braking by maintaining the same warning and braking distances as those in driving on the general road and calculating a required deceleration amount, if a driver's vehicle operating intention is sensed.

17. The autonomous emergency braking system according to claim 14, wherein the required deceleration amount is calculated as
$${A}_{req} = \frac{{V}_{rel}^{2}}{2 \times {D}_{rel}} ,$$
wherein A_{req} is the required deceleration amount, Vᵣₑₗ is a relative speed between the host vehicle and a preceding vehicle, and Dᵣₑₗ is a relative distance between the host vehicle and the preceding vehicle.

18. An autonomous emergency braking method comprising:
receiving a driving speed of a host vehicle and distances and relative speeds between the host vehicle and peripheral objects or an image around the host vehicle from sensors;
determining whether or not the host vehicle drives on a highway according to the information received from the sensors;
determining whether or not lane keeping assist (LKA) and smart cruise control (SCC) are executed, if it is determined that the host vehicle drives on the highway; and
executing control so as to activate a safety-preferred control mode during autonomous emergency braking (AEB), if it is determined that the lane keeping assist (LKA) and the smart cruise control (SCC) are executed.

19. The autonomous emergency braking method according to claim 18, wherein the safety-preferred control mode is a mode configured to execute parabolic braking control by advancing warning and braking operation times by increasing warning and braking distances, as compared to driving on a general road, and calculating a required deceleration amount.

20. The autonomous emergency braking method according to claim 19, wherein the executing the control comprises executing stepwise braking control in which full braking is carried out after pre-braking by maintaining the same warning and braking distances as those in driving on the general road and calculating a required deceleration amount, in a situation in which the host vehicle does not drive on the highway, or the host vehicle drives on the highway but the lane keeping assist (LKA) and the smart cruise control (SCC) are not executed.

21. The autonomous emergency braking method according to claim 19, wherein the executing the control comprises executing stepwise braking control in which full braking is carried out after pre-braking by maintaining the same warning and braking distances as those in driving on the general road and calculating a required deceleration amount, if a driver's vehicle operating intention is sensed.

22. The autonomous emergency braking method according to claim 19, wherein the required deceleration amount is calculated as
$${A}_{req} = \frac{{V}_{rel}^{2}}{2 \times {D}_{rel}} ,$$
wherein A_{req} is the required deceleration amount, Vᵣₑ is a relative speed between the host vehicle and a preceding vehicle, and Dᵣₑₗ is a relative distance between the host vehicle and the preceding vehicle.
